(19) United States
(12) Patent Application Publication
(10) Pub. No.: US 2022/0252779 A1
(43) Pub. Date: Aug. 11, 2022

(54) METHOD FOR AMORPHOUS, HIGH-REFRACTIVE-INDEX ENCAPSULATION OF NANOPARTICLE IMPRINT FILMS FOR OPTICAL DEVICES

(71) Applicant: Applied Materials, Inc., Santa Clara, CA (US)

(72) Inventor: Andrew CEBALLOS, Santa Clara, CA (US)

(21) Appl. No.: 17/170,342

(22) Filed: Feb. 8, 2021

(51) Int. Cl. F21V 8/00; C03C 19/00

(52) U.S. Cl. CPC G02B 6/0036; G02B 2207/101; C03C 19/00; G02B 6/0065

(57) ABSTRACT

Embodiments provided herein provide for amorphous encapsulation of nanoparticle imprint films for optical devices. In one embodiment provided herein, a device is provided. The device includes a plurality of optical device structures disposed on a surface of a substrate. The plurality of optical device structures include a nanoparticle imprint material. The plurality of optical device structures further include an encapsulation layer disposed over at least a top surface and one sidewall of each optical device structure of the plurality of optical device structures. The encapsulation layer is amorphous or substantially amorphous. The encapsulation layer includes a niobium oxide. The niobium oxide is selected from the group consisting of niobium monoxide (NbO), niobium dioxide (NbO₂), niobium pentoxide (Nb₂O₅), Nb₁₂O₂₉, Nb₄₇O₁₁₆, or Nb3n₊₁O₈ₙ₋₂, where n is 5 to 8.

### BACKGROUND

### Field

Embodiments of the present disclosure generally relate to optical devices for augmented, virtual, and mixed reality. More specifically, embodiments described herein provide for amorphous encapsulation of nanoparticle imprint films for optical devices.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated to appear as part of the environment. Augmented reality can include any type of input, such as audio and haptic inputs, as well as virtual images, graphics, and video that enhance or augment the environment that the user experiences. As an emerging technology, there are many challenges and design constraints with augmented reality.

One such challenge is displaying a virtual image overlaid on an ambient environment. Optical devices including waveguide combiners, such as augmented reality waveguide combiners, and flat optical devices, such as metasurfaces, are used to assist in overlaying images. Generated light is propagated through an optical device until the light exits the optical device and is overlaid on the ambient environment.

The optical devices may include an encapsulation layer disposed over a top surface and at least one sidewall of the optical device structures. In some instances, the encapsulation layer must have a refractive index greater than or equal to 2.0, i.e., a high refractive index. However, cracks in the encapsulation layer may form when the encapsulation layer is disposed over crystalline or nano-crystalline optical device structures formed from nanoparticle imprint films. The cracks in the high refractive index encapsulation layer may reduce the functionality of optical devices.

Accordingly, what is needed in the art are optical devices with an amorphous or substantially amorphous encapsulation layer and methods of forming optical devices with the amorphous or substantially amorphous encapsulation layer.

### SUMMARY

In one embodiment, a device is provided. The device includes a plurality of optical device structures disposed on a surface of a substrate. The plurality of optical device structures include a nanoparticle imprint material. The plurality of optical device structures further include an encapsulation layer disposed over at least a top surface and one sidewall of each optical device structure of the plurality of optical device structures. The encapsulation layer is amorphous or substantially amorphous. The encapsulation layer includes a niobium oxide. The niobium oxide is selected from the group consisting of niobium monoxide (NbO), niobium dioxide (NbO₂), niobium pentoxide (Nb₂O₅), Nb₁₂O₂₉, Nb₄₇O₁₁₆, or Nb3n₊₁O₈ₙ₋₂, where n is 5 to 8.

In another embodiment, a device is provided. The device includes a plurality of optical device structures disposed on a substrate. The plurality of optical device structures include a nanoparticle imprint material. The plurality of optical device structures further include a buffer layer disposed over a top surface and at least one sidewall of each optical device structure of the plurality of optical device structures. The plurality of optical device structures further include an encapsulation layer disposed over the buffer layer. The encapsulation layer includes materials having a refractive index greater than or equal to 2.0.

In yet another embodiment, a method is provided. The method includes imprinting a stamp into a nanoparticle imprint material disposed on a surface of a substrate to form a plurality of optical device structures. The method further includes subjecting the nanoparticle imprint material to a cure process. The method further includes releasing the stamp from the nanoparticle imprint material. The method further includes disposing an encapsulation layer to be conformal over at least a top surface and one sidewall of each optical device structure of the plurality of optical device structures. The encapsulation layer is amorphous or substantially amorphous. The encapsulation layer includes a niobium oxide. The niobium oxide is selected from the group consisting of niobium monoxide (NbO), niobium dioxide (NbO₂), niobium pentoxide (Nb₂O₅), Nb₁₂O₂₉, Nb₄₇O₁₁₆, or Nb3n₊₁O₈ₙ₋₂, where n is 5 to 8.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A is a schematic, top view of an optical device according to embodiments.

FIG. 1B is schematic, top view of an optical device according to embodiments.

FIGS. 2A-2D are schematic, cross-sectional views of a portion of an optical device according to embodiments.

FIGS. 3A-3C are cross-sectional views of a portion of an optical device structure according to embodiments.

FIG. 4 is a flow diagram of a method for forming an optical device according to embodiments.

FIGS. 5A-5C are schematic, cross-sectional views of a portion of an optical device according to embodiments.

FIG. 6 is a flow diagram of a method for forming an optical device according to embodiments.

FIGS. 7A-7D are schematic, cross-sectional views of a portion of an optical device according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices for augmented, virtual, and mixed reality. More specifically, embodiments described herein provide for optical devices with an amorphous or substantially amorphous encapsulation layer and methods of forming optical devices with the amorphous or substantially amorphous encapsulation layer. In one embodiment, a device is provided. The device includes a plurality of optical device structures disposed on a surface of a substrate. The plurality of optical device structures include a nanoparticle imprint material. The plurality of optical device structures further include an encapsulation layer disposed over at least a top surface and one sidewall of each optical device structure of the plurality of optical device structures. The encapsulation layer is amorphous or substantially amorphous. The encapsulation layer includes a niobium oxide. The niobium oxide is selected from the group consisting of niobium monoxide (NbO), niobium dioxide (NbO₂), niobium pentoxide (Nb₂O₅), Nb₁₂O₂₉, Nb₄₇O₁₁₆, or Nb3n₊₁O₈ₙ₋₂, where n is 5 to 8.

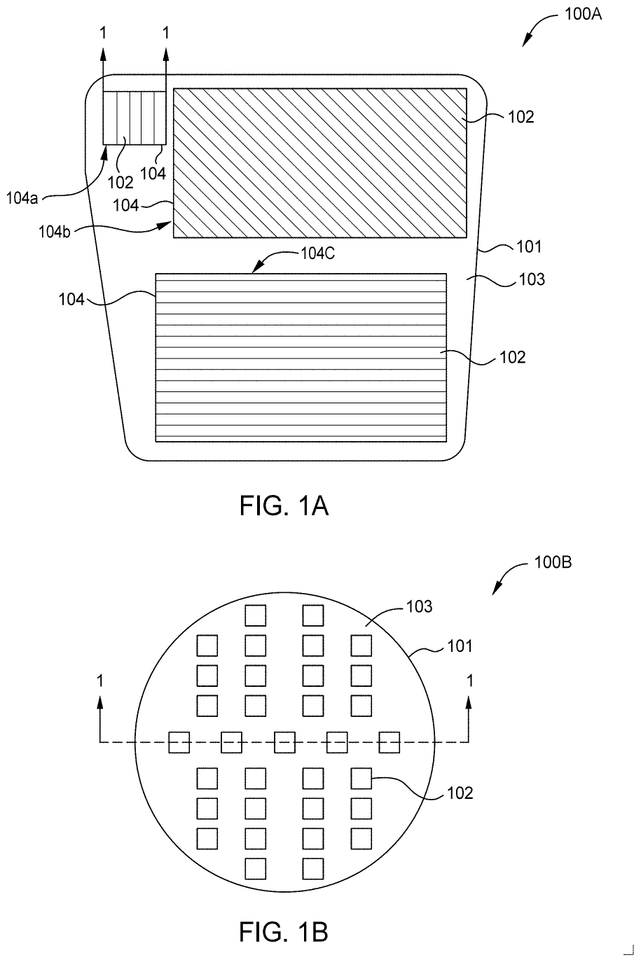

FIG. 1A is a schematic, top view of an optical device 100A. FIG. 1B is a schematic, top view of an optical device 100B. It is to be understood that the optical devices 100A and 100B described below are exemplary optical devices. In one embodiment, which can be combined with other embodiments described herein, the optical device 100A is a waveguide combiner, such as an augmented reality waveguide combiner. In another embodiment, which can be combined with other embodiments described herein, the optical device 100B is a flat optical device, such as a metasurface.

The optical devices 100A and 100B include a plurality of optical device structures 102 disposed on a surface 103 of a substrate 101. The optical device structures 102 may be nanostructures having sub-micron dimensions, e.g., nano-sized dimensions. In one embodiment, which can be combined with other embodiments described herein, regions of the optical device structures 102 correspond to one or more gratings 104, such as a first grating 104a, a second grating 104b, and a third grating 104c. In one embodiment, which can be combined with other embodiments described herein, the optical device 100A is a waveguide combiner that includes at least the first grating 104a corresponding to an input coupling grating and the third grating 104c corresponding to an output coupling grating. The waveguide combiner according to the embodiment, which can be combined with other embodiments described herein, includes the second grating 104b corresponding to an intermediate grating. While FIG. 1B depicts the optical device structures 102 as having square or rectangular shaped cross-sections, the cross-sections of the optical device structures 102 may have other shapes including, but not limited to, circular, triangular, elliptical, regular polygonal, irregular polygonal, and/or irregular shaped cross-sections. In some embodiments, which can be combined with other embodiments described herein, the cross-sections of the optical device structures 102 on a single optical device 100B are different.

The substrate 101 may be formed from any suitable material, provided that the substrate 101 can adequately transmit light in a desired wavelength or wavelength range and can serve as an adequate support for the optical device 100A and the optical device 100B, described herein. In some embodiments, which can be combined with other embodiments described herein, the material of the substrate 101 has a refractive index that is relatively low, as compared to the refractive index of the plurality of optical device structures 102. Substrate selection may include substrates of any suitable material, including, but not limited to, amorphous dielectrics, non-amorphous dielectrics, crystalline dielectrics, silicon oxide, polymers, and combinations thereof. In some embodiments, which may be combined with other embodiments described herein, the substrate 101 includes a transparent material. In one example, the substrate 101 includes silicon (Si), silicon dioxide (SiO₂), germanium (Ge), silicon germanium (SiGe), InP, GaAs, GaN, fused silica, quartz, sapphire, and high-index transparent materials such as high-refractive-index glass.

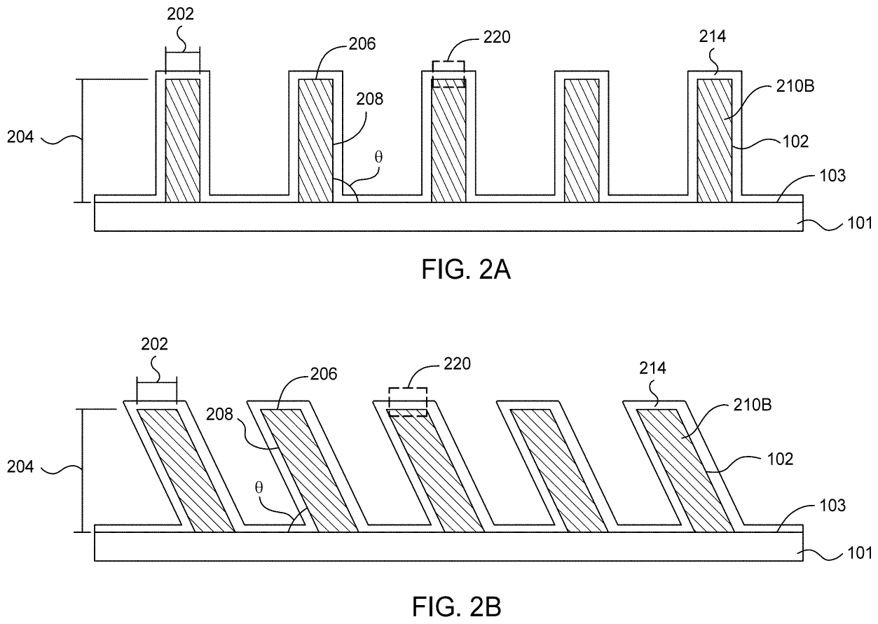

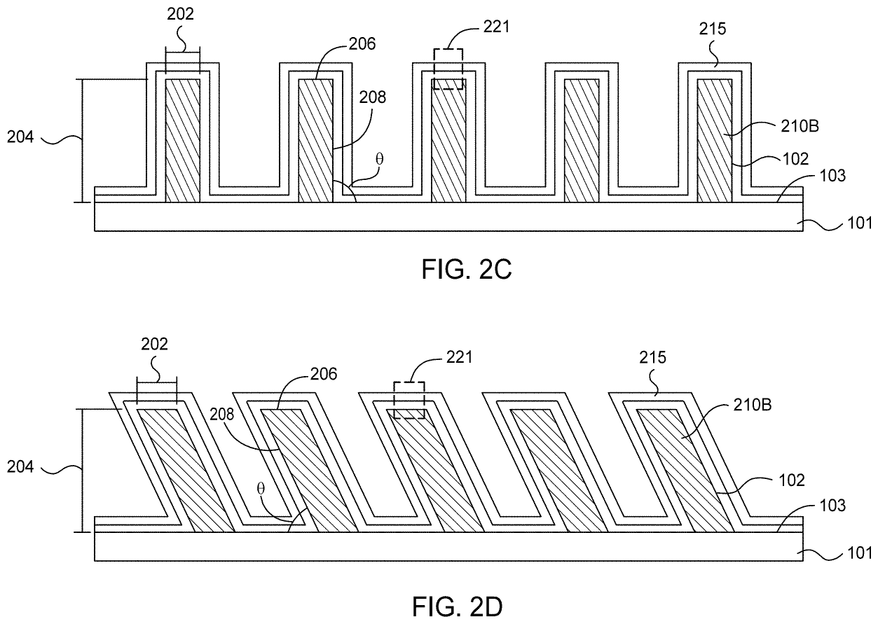

FIGS. 2A-2D are schematic, cross-sectional views of a portion of an optical device taken along section line 1-1 of FIG. 1A or FIG. 1B. In one embodiment, which can be combined with other embodiments described herein, the plurality of optical device structures 102 correspond to the first grating 104a, the second grating 104b, or the third grating 104c of the optical device 100A. The plurality of optical device structures 102 are disposed on the surface 103 of the substrate 101. Each optical device structure 102 of the plurality of optical device structures 102 has an optical device structure width 202. In one embodiment, which can be combined with other embodiments described herein, at least one optical device structure width 202 may be different from another optical device structure width 202. In another embodiment, which can be combined with other embodiments described herein, each optical device structure width 202 of the plurality of optical device structures 102 is substantially equal to each other optical device structure width 202.

Each optical device structure 102 of the plurality of optical device structures 102 has a depth 204. In one embodiment, which can be combined with other embodiments described herein, at least one depth 204 of the plurality of optical device structures 102 is different that the depth 204 of the other optical device structures 102. In another embodiment, which can be combined with other embodiments described herein, each depth 204 of the plurality of optical device structures 102 is substantially equal to the adjacent optical device structures 102.

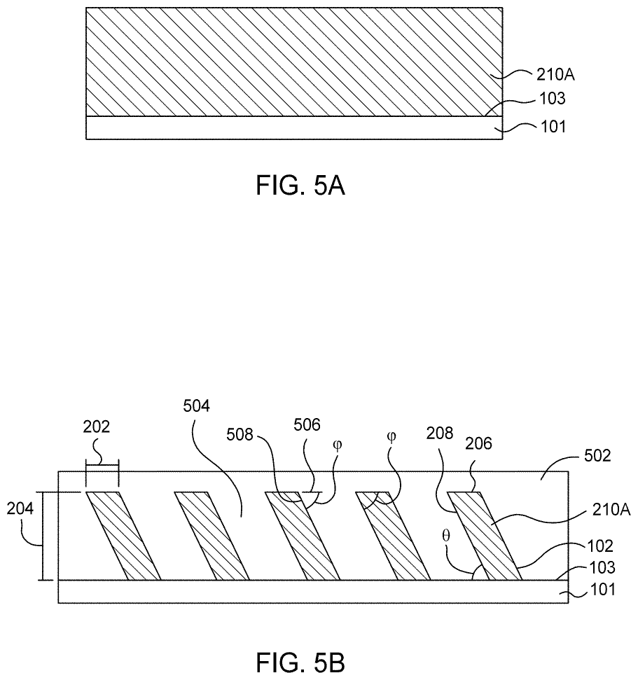

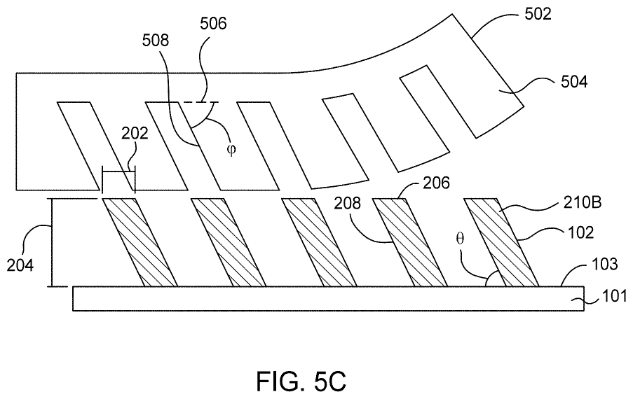

The plurality of optical device structures 102 are initially formed from a malleable nanoparticle imprint material 210A, as shown in FIGS. 5A and 5B. The malleable nanoparticle imprint material 210A is cured such that the plurality of optical device structures 102 consist of an unmalleable nanoparticle imprint material 210B. The plurality of optical device structures 102 are crystalline or nano-crystalline due to the unmalleable nanoparticle imprint material 110B. In some embodiments, which can be combined with other embodiments described herein, the plurality of optical devices 102 formed from the unmalleable nanoparticle imprint material 210B have a refractive index greater than about 1.5. In one embodiment, which can be combined with other embodiments described herein, the plurality of optical devices 102 formed from the unmalleable nanoparticle imprint material 210B have a refractive index between about 1.8 and about 2.1. In another embodiment, which can be combined with other embodiments described herein, the plurality of optical devices 102 formed from the unmalleable nanoparticle imprint material 210B have a refractive index between about 3.5 and about 4.0.

In one embodiment, which can be combined with other embodiments described herein, the malleable nanoparticle imprint material 210A and the unmalleable nanoparticle imprint material 210B includes, but are not limited to, one or more of spin on glass (SOG), flowable SOG, organic, inorganic, hybrid organic, and inorganic nanoimprintable materials. The malleable nanoparticle imprint material 210A and the unmalleable nanoparticle imprint material 210B may include silicon oxycarbide (SiOC), titanium dioxide (TiO₂), silicon dioxide (SiO₂), vanadium (IV) oxide (VO₂), aluminum oxide (Al₂O₃), indium tin oxide (ITO), zinc oxide (ZnO), tantalum pentoxide (Ta₂O₅), silicon nitride (Si₃N₄), titanium nitride (TiN), or zirconium dioxide (ZrO₂) containing materials.

The plurality of optical device structures 102 are formed at a device angle ϑ. The device angle ϑ is the angle between the surface 103 of the substrate 101 and the sidewall 208 of the optical device structure 102. As shown in FIGS. 2A and 2C, the plurality of optical devices 102 are vertical, i.e., the device angle ϑ is 90 degrees. As shown in FIGS. 2B and 2D, the plurality of optical devices 102 are angled relative to the surface 103 of the substrate 101. In one embodiment, which can be combined with other embodiments described herein, each respective device angle ϑ for each optical device structure 102 is substantially equal. In another embodiment, which can be combined with other embodiments described herein, at least one respective device angle ϑ of the plurality of optical device structures 102 is different than another device angle ϑ of the plurality of optical device structures 102.

As shown in FIGS. 2A and 2B, an encapsulation layer 214 including niobium oxide is disposed over the plurality of optical device structures 102 and the surface 103 of the substrate 101. The niobium oxide is selected from the group consisting of niobium monoxide (NbO), niobium dioxide (NbO₂), niobium pentoxide (Nb₂O₅), Nb₁₂O₂₉, Nb₄₇O₁₁₆, or Nb3n₊₁O₈ₙ₋₂, where n is 5 to 8. Examples of Nb3n₊₁O₈ₙ₋₂ include Nb₈O₁₉ and Nb₁₆O₃₈. In one embodiment, which can be combined with other embodiments described herein, the encapsulation layer 214 including the niobium oxide has a refractive index between about 2.1 and about 2.5. In one embodiment, which can be combined with other embodiments described herein, the encapsulation layer 214 is deposited such that the encapsulation layer 214 is disposed over at least a top surface 206 and one sidewall 208 of each optical device structure 102 of the plurality of optical device structures 102. In another embodiment, which can be combined with other embodiments described herein, the encapsulation layer 214 is disposed over the top surface 206 and both sidewalls 208 of each optical device structure 102 of the plurality of optical device structures 102 and over the surface 103 of the substrate 101. The encapsulation layer 214 may be disposed using a liquid material pour casting process, a spin-on coating process, a liquid spray coating process, a dry powder coating process, a screen printing process, a doctor blading process, a PVD process, a CVD process, a FCVD process, a PECVD process, or an ALD process.

As shown in FIGS. 2C and 2D, an encapsulation layer 215 includes one or more materials with a refractive index greater than or equal to 2.0, i.e., a high refractive index. The materials can include one or more of silicon oxycarbide, titanium oxide, silicon oxide, vanadium oxide, aluminum oxide, aluminum-doped zinc oxide, indium tin oxide, tin dioxide, zinc oxide, tantalum pentoxide, silicon nitride, silicon oxynitride, zirconium oxide, niobium oxide, cadmium stannate, or silicon carbon-nitride containing materials. The encapsulation layer 215 is deposited over a buffer layer 212. In one embodiment, which can be combined with other embodiments described herein, the buffer layer 212 is deposited over the top surface 206 and at least one sidewall 208 of each optical devices structure 102 of the plurality of optical device structures 102. In another embodiment, which can be combined with other embodiments described herein, the encapsulation layer 214 is disposed over the top surface 206 and both sidewalls 208 of each optical device structure 102 of the plurality of optical device structures 102 and over the surface 103 of the substrate 101.

The buffer layer 212 may be disposed using a liquid material pour casting process, a spin-on coating process, a liquid spray coating process, a dry powder coating process, a screen printing process, a doctor blading process, a PVD process, a CVD process, a FCVD process, a PECVD process, or an ALD process. The buffer layer 212 includes, but is not limited to, at least one or more of silicon oxycarbide, titanium oxide, silicon oxide, vanadium oxide, aluminum oxide, aluminum-doped zinc oxide, indium tin oxide, tin dioxide, zinc oxide, tantalum pentoxide, silicon nitride, silicon oxynitride, zirconium oxide, niobium oxide, cadmium stannate, or silicon carbon-nitride containing materials or combinations thereof.

In one embodiment, which can be combined with other embodiments described herein, the refractive index of either the buffer layer 212 or the encapsulation layer 215 with a titanium oxide material is between about 2.3 and about 2.7. In another embodiment, which can be combined with other embodiments described herein, the refractive index of either the buffer layer 212 or the encapsulation layer 215 with a tantalum pentoxide material is between about 2.0 and about 2.2. In yet another embodiment, which can be combined with other embodiments described herein, the refractive index of either the buffer layer 212 or the encapsulation layer 215 with a zirconium oxide material is between about 2.0 and about 2.2.

The refractive index of the buffer layer is greater than or equal to about 1.8. In one embodiment, which can be combined with other embodiments described herein, the buffer layer 212 and the plurality of optical device structures 102 have the same refractive index. In another embodiment, which can be combined with other embodiments described herein, the buffer layer 212 and the encapsulation layer 215 have the same refractive index. In yet another embodiment, which can be combined with other embodiments described herein, the refractive index of the buffer layer 212 is between the refractive index of the plurality of optical device structures 102 and the encapsulation layer 115.

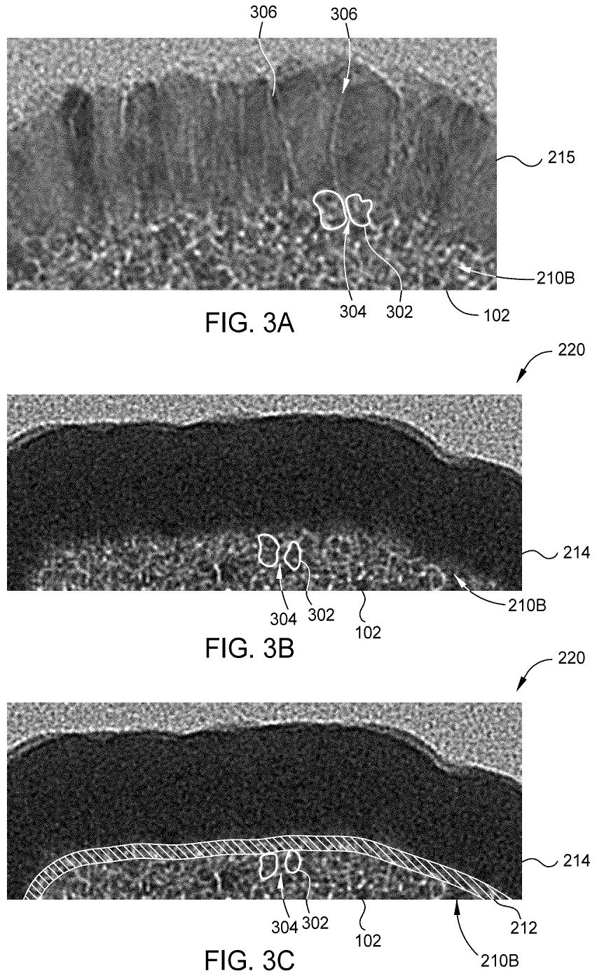

FIGS. 3A is a cross-sectional view of an optical device structure 102 with the encapsulation layer 215. FIG. 3C is a cross-sectional view of a portion 221 of an optical device structure 102 with the encapsulation layer 215. The encapsulation layer 215 includes one or more materials with a refractive index greater than or equal to 2.0 i.e., a high refractive index. The materials can include one or more of silicon oxycarbide, titanium oxide, silicon oxide, vanadium oxide, aluminum oxide, aluminum-doped zinc oxide, indium tin oxide, tin dioxide, zinc oxide, tantalum pentoxide, silicon nitride, zirconium oxide, niobium oxide, cadmium stannate, or silicon carbon-nitride containing materials. FIG. 3B is a cross-sectional view of a portion 220 of an optical device structure 102 with the encapsulation layer 214. The encapsulation layer 214 includes a niobium oxide. The niobium oxide selected from the group consisting of niobium monoxide (NbO), niobium dioxide (NbO₂), niobium pentoxide (Nb₂O₅), Nb₁₂O₂₉, Nb₄₇O₁₁₆, or Nb3n₊₁O₈ₙ₋₂, where n is 5 to 8. Examples of Nb3n₊₁O₈ₙ₋₂ include Nb₈O₁₉ and Nb₁₆O₃₈.

Each optical device structure 102 of the plurality of optical device structures 102 includes the unmalleable nanoparticle imprint material 210B. The unmalleable nanoparticle imprint material 210B has a plurality of nanoparticles 302. The plurality of nanoparticles 302 are crystals or nano-crystals that can lead to crystalline formations in subsequent depositions over the plurality of optical devices 102. Adjacent nanoparticles 302 of the plurality of nanoparticles 302 define a plurality of grain boundaries 304. A grain boundary 304 of the plurality of grain boundaries 304 is present at any interface between adjacent nanoparticles 302.

As shown in FIG. 3A, the encapsulation layer 215 includes a titanium oxide material. The encapsulation layer 215 includes a plurality of cracks 306. The cracks 306 are induced by the adjacent grain boundaries 304 in the unmalleable nanoparticle imprint material 210B. The plurality of grain boundaries 304 propagate into the encapsulation layer 215 to form the cracks 306 when the encapsulation layer 215 is non-amorphous. The cracks 306 lead to degradation of the underlying plurality of optical device structures 102 and reduce functionality of the optical device 100A or the optical device 100B.

As shown in FIG. 3B, the encapsulation layer 214 including the niobium oxide is lacking or substantially lacking cracks 306. In one embodiment, which can be combined with other embodiments described herein, the encapsulation layer 214 including the niobium oxide has a refractive index between about 2.1 and about 2.5. The niobium oxide is amorphous or substantially amorphous such that the plurality of grain boundaries 304 are not induced in the encapsulation layer 214. The encapsulation layer 214 including the niobium oxide provides a higher encapsulation quality as the amorphous or substantially amorphous properties lead to a smoother encapsulation layer 214 and provide less variation in the optical properties of the underlying optical device structures 102. Additionally, the encapsulation layer 214 including the niobium oxide is substantially less sensitive to temperature than the encapsulation layer 215. Therefore, the optical devices 100A and 100B with the encapsulation layer 214 will lead to higher throughput.

As shown in FIG. 3C, the encapsulation layer 215 includes one or more materials with a refractive index greater than or equal to 2.0, i.e., a high refractive index. The encapsulation layer 215 is disposed over the buffer layer 212. The buffer layer 212 provides a barrier between the plurality of nanoparticles 302 and the encapsulation layer 215 such that cracks 306 do not form in the encapsulation layer 215.

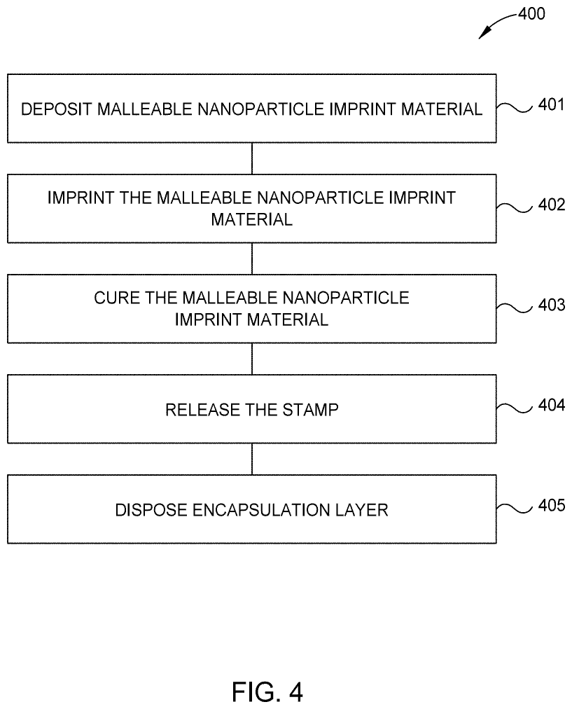

FIG. 4 is a flow diagram of a method 400 for forming the optical devices 100A and 100B, as shown in FIGS. 5A-5C. FIGS. 5A-5D are schematic, cross-sectional views of a portion 105 of the optical device 100A or the optical device 100B. At operation 401, as shown in FIG. 5A, a malleable nanoparticle imprint material 210A is deposited on a surface 103 of a substrate 101. The malleable nanoparticle imprint material 210A is deposited using a deposition process. The deposition process may include a spin on process, liquid material pour casting process, a liquid spray coating process, a dry powder coating process, a screen printing process, a doctor blading process, a PVD process, a CVD process, a FCVD process, or an ALD process. In one embodiment, which can be combined with other embodiments described herein, the malleable nanoparticle imprint material 210A is deposited with a spin on process.

In one embodiment, which can be combined with other embodiments described herein, the malleable nanoparticle imprint material 210A includes, but is not limited to, one or more of spin on glass (SOG), flowable SOG, organic, inorganic, hybrid organic, and inorganic nanoimprintable materials. The malleable nanoparticle imprint material 210A may include silicon oxycarbide (SiOC), titanium dioxide (TiO₂), silicon dioxide (SiO₂), vanadium (IV) oxide (VO₂), aluminum oxide (Al₂O₃), indium tin oxide (ITO), zinc oxide (ZnO), tantalum pentoxide (Ta₂O₅), silicon nitride (Si₃N₄), titanium nitride (TiN), or zirconium dioxide (ZrO₂) containing materials.

At operation 402, as shown in FIG. 5B, a stamp 502 is imprinted into the malleable nanoparticle resist material 210A. In one embodiment, the malleable nanoparticle imprint material 210A is heated to a preheat temperature before the stamp 502 is imprinted. The stamp 502 has a plurality of inverse structures 504. The plurality of inverse structures 504 are imprinted into the malleable nanoparticle imprint material 210A to form a plurality of optical device structures 102. The plurality of optical device structures 102 have a device angle ϑ. The device angle ϑ is the angle between the surface 103 of the substrate 101 and the sidewall 208 of the optical device structure 102. The stamp 502 is molded such that the plurality of inverse structures 504 are at a stamp angle φ. The stamp angle φ is the angle between a plane 506 parallel with the surface103 and a sidewall 508 of the plurality of inverse structures 504. In one embodiment, which can be combined with other embodiments described herein, the stamp angle φ will correspond to the device angle ϑ when the stamp 502 is imprinted into the nanoparticle resist material 210A.

The stamp 502 is molded from a master and may be made from a semi-transparent material, such as fused silica or polydimethylsiloxane (PDMS) material, or a transparent material, such as a glass material or a plastic material, to allow the nanoim print resist to be cured by exposure to electromagnetic radiation, such as infrared (IR) radiation or ultraviolet (UV) radiation. In one embodiment, the stamp 502 may be coated with a mono-layer of anti-stick surface treatment coating, such as a fluorinated coating, so the stamp 502 can be mechanically removed by a machine tool or by hand peeling. Although FIGS. 5B and 5C show the plurality of inverse structures 504 of the stamp 502 and the plurality of optical device structures 102 as being at an angle relative to the surface 103 of the substrate 101, the plurality of inverse structures 504 and plurality of optical device structures 102 may be vertical i.e., the stamp angle φ and the device angle ϑ are 90°, as shown in FIGS. 2A and 2C.

At operation 403, the malleable nanoparticle imprint material 210A is subjected to a cure process. In one embodiment, the malleable nanoparticle imprint material 210A is subjected to the cure process to form the nonmalleable nanoparticle imprint material 210B. The cure process includes exposing the nanoparticle imprint material 210 to electromagnetic radiation, such as infrared (IR) radiation or ultraviolet (UV) radiation. The unmalleable nanoparticle imprint material 210B is rigid such that the unmalleable nanoparticle imprint material 210B is crystalline or nano-crystalline.

At operation 404, as shown in FIG. 5C, the stamp 502 is released. In one embodiment, which can be combined with other embodiments described herein, the stamp 502 is peeled at the release angle relative to the surface 103 of the substrate 101. In another embodiment, which can be combined with other embodiments described herein, the stamp 502 is mechanically peeled by a machine tool at the release angle. In yet another embodiment, the stamp 502 is peeled by hand at the release angle. The release angle is about 0° to about 180°. In another embodiment, which can be combined with other embodiments described herein, the unmalleable nanoparticle imprint material 210B is subjected to an anneal process after the operation 404. The anneal process includes exposing the nanoparticle imprint material 210 to electromagnetic radiation, such as infrared (IR) radiation or ultraviolet (UV) radiation, until the unmalleable nanoparticle imprint material 210B reaches an anneal state.

At operation 405, as shown in FIG. 2B, an encapsulation layer 214 is disposed. The encapsulation layer 214 is disposed over the plurality of optical device structures 102. The encapsulation layer 214 is disposed over a top surface 206 and at least one sidewall 208 of each optical device structure 102 of the plurality of optical device structures 102. The encapsulation layer 214 is disposed using a liquid material pour casting process, a spin-on coating process, a liquid spray coating process, a dry powder coating process, a screen printing process, a doctor blading process, a PVD process, a CVD process, a FCVD process, a PECVD process, or an ALD process. The encapsulation layer 214 includes a niobium oxide. The niobium oxide selected from the group consisting of niobium monoxide (NbO), niobium dioxide (NbO₂), niobium pentoxide (Nb₂O₅), Nb₁₂O₂₉, Nb₄₇O₁₁₆, or Nb3n₊₁O₈ₙ₋₂, where n is 5 to 8. Examples of Nb3n₊₁O₈ₙ₋₂ include Nb₈O₁₉ and Nb₁₆O₃₈. In one embodiment, which can be combined with other embodiments described herein, the encapsulation layer 214 including the niobium oxide has a refractive index between about 2.1 and about 2.5.

In one embodiment, which can be combined with other embodiments described herein, the encapsulation layer 214 including the niobium oxide will be deposited onto the unmalleable nanoparticle imprint material 210B. The encapsulation layer 214 is amorphous or substantially amorphous such that the plurality of grain boundaries 304 in the unmalleable nanoparticle imprint material 210B do not propagate to the encapsulation layer 114.

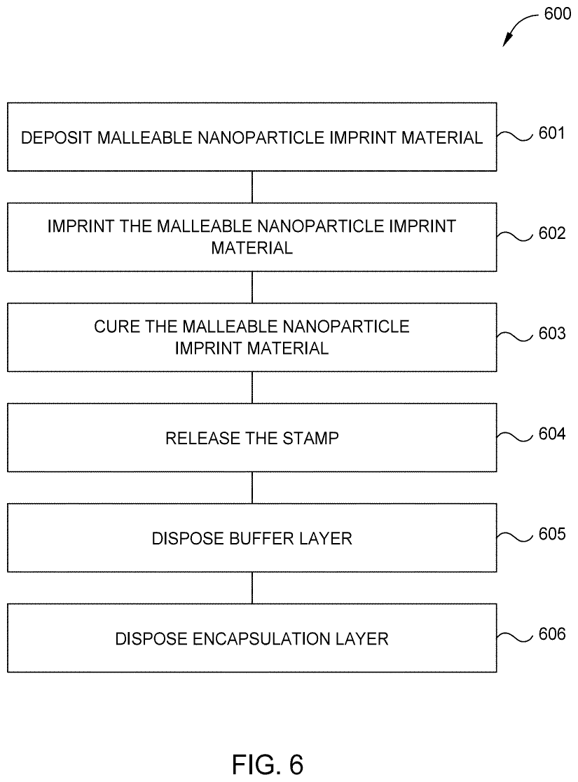

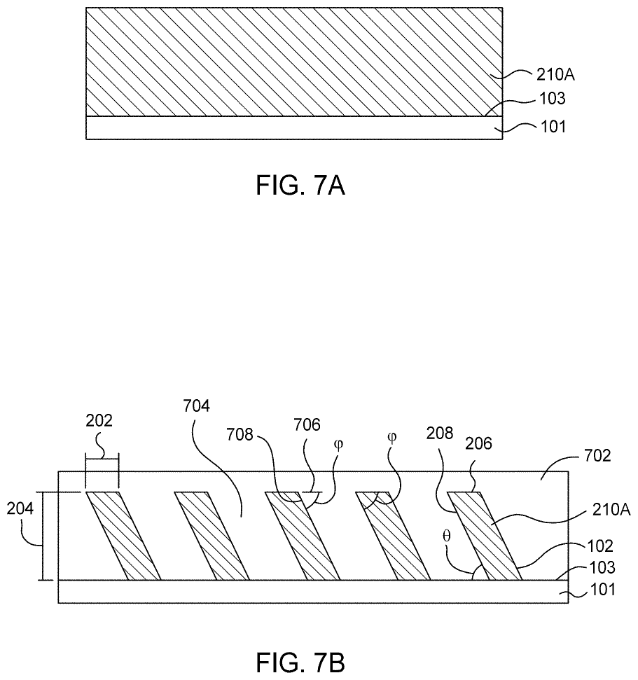

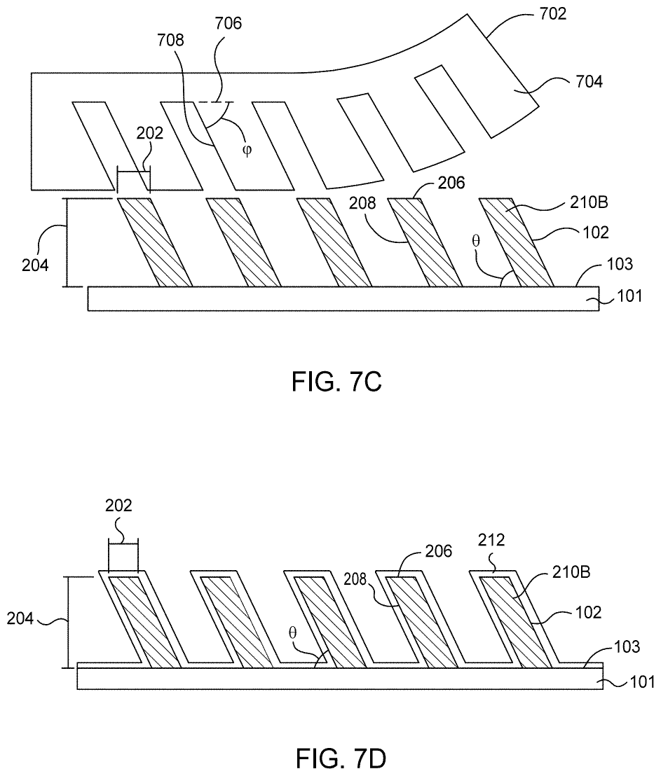

FIG. 6 is a flow diagram of a method 600 for forming the optical devices 100A and 100B, as shown in FIGS. 7A-7D. FIGS. 7A-7D are schematic, cross-sectional views of a portion 105 of the optical device 100A or the optical device 100B. At operation 601, as shown in FIG. 7A, a malleable nanoparticle imprint material 210A is deposited on a surface 103 of a substrate 101.

At operation 602, as shown in FIG. 7B, a stamp 702 is imprinted into the malleable nanoparticle resist material 210A. In one embodiment, the malleable nanoparticle imprint material 210A is heated to a preheat temperature before the stamp 502 is imprinted. The stamp 702 has a plurality of inverse structures 704. The plurality of inverse structures 704 are imprinted into the malleable nanoparticle imprint material 210A to form a plurality of optical device structures 102. The plurality of optical device structures 102 have a device angle ϑ. The device angle ϑ is the angle between the surface 103 of the substrate 101 and the sidewall 208 of the optical device structure 102. The stamp 702 is molded such that the plurality of inverse structures 704 are at a stamp angle φ. The stamp angle φ is the angle between a plane 706 parallel with the surface 103 and a sidewall 708 of the plurality of inverse structures 704. In one embodiment, which can be combined with other embodiments described herein, the stamp angle φ will correspond to the device angle ϑ when the stamp 702 is imprinted into the nanoparticle resist material 210A.

The stamp 702 is molded from a master and may be made from a semi-transparent material, such as fused silica or polydimethylsiloxane (PDMS) material, or a transparent material, such as a glass material or a plastic material, to allow the nanoim print resist to be cured by exposure to electromagnetic radiation, such as infrared (IR) radiation or ultraviolet (UV) radiation. In one embodiment, the stamp 702 may be coated with a mono-layer of anti-stick surface treatment coating, such as a fluorinated coating, so the stamp 702 can be mechanically removed by a machine tool or by hand peeling. Although FIGS. 7B and 7C show the plurality of inverse structures 704 of the stamp 702 and the plurality of optical device structures 102 as being at an angle relative to the surface 103 of the substrate 101, the plurality of inverse structures 704 and plurality of optical device structures 102 may be vertical i.e., the stamp angle φ and the device angle ϑ are 90°, as shown in FIGS. 2A and 2C.

At operation 603, the malleable nanoparticle imprint material 210A is subjected to a cure process. In one embodiment, the malleable nanoparticle imprint material 210A is subjected to the cure process to form the nonmalleable nanoparticle imprint material 210B. The cure process includes exposing the nanoparticle imprint material 210 to electromagnetic radiation, such as infrared (IR) radiation or ultraviolet (UV) radiation. The unmalleable nanoparticle imprint material 210B is rigid such that the unmalleable nanoparticle imprint material 210B is crystalline or nano-crystalline.

At operation 604, as shown in FIG. 7C, the stamp 502 is released. In one embodiment, which can be combined with other embodiments described herein, the stamp 502 is peeled at the release angle relative to the surface 103 of the substrate 101. In another embodiment, which can be combined with other embodiments described herein, the stamp 502 is mechanically peeled by a machine tool at the release angle. In yet another embodiment, the stamp 502 is peeled by hand at the release angle. The release angle is about 0° to about 180°. In another embodiment, which can be combined with other embodiments described herein, the unmalleable nanoparticle imprint material 210B is subjected to an anneal process after the operation 404. The anneal process includes exposing the nanoparticle imprint material 210 to electromagnetic radiation, such as infrared (IR) radiation or ultraviolet (UV) radiation, until the unmalleable nanoparticle imprint material 210B reaches an anneal state.

At operation 605, a buffer layer 212 is disposed. The buffer layer 212 is disposed over the plurality of optical device structures 102. The buffer layer 212 is deposited over the top surface 206 and at least one sidewall 208 of each optical device structure 102 of the plurality of optical device structures 102. The buffer layer is deposited using a liquid material pour casting process, a spin-on coating process, a liquid spray coating process, a dry powder coating process, a screen printing process, a doctor blading process, a PVD process, a CVD process, a FCVD process, a PECVD process, or an ALD process.

At operation 606, as shown in FIG. 2D, the encapsulation layer 215 is disposed. The encapsulation layer 215 is disposed over the buffer layer 212. The encapsulation layer 215 includes a high-refractive index material such as titanium oxide (TiO) or zirconium oxide (ZrO) materials. The buffer layer 212 provides a barrier between the unmalleable nanoparticle imprint material 210B and the encapsulation layer 215. Therefore, the encapsulation layer 215 will be absent or substantially absent of the plurality of cracks 306.

In one embodiment, which can be combined with other embodiments described herein, the encapsulation layer 214 including the niobium oxide will be deposited onto the unmalleable nanoparticle imprint material 210B. The encapsulation layer 214 will be absent or substantially absent of the plurality of cracks 306. The encapsulation layer 214 is amorphous or substantially amorphous such that the plurality of grain boundaries 304 in the unmalleable nanoparticle imprint material 210B do not propagate to the encapsulation layer 114.

In summation, optical devices with an amorphous or substantially amorphous encapsulation layer and methods of forming optical devices with the amorphous or substantially amorphous encapsulation layer are described herein. The encapsulation layer including the niobium oxide is deposited over the plurality of optical device structures. The encapsulation layer including the niobium oxide, as described herein, is amorphous or substantially amorphous such that the encapsulation layer is less prone to forming cracks in the encapsulation layer. Additionally, a buffer layer can be disposed over the plurality of optical device structures to provide a barrier between the optical device structures and an encapsulation layer to prevent cracks in the encapsulation layer. Therefore, the encapsulation quality of the optical device is improved due to the amorphous encapsulation layer.

While the foregoing is directed to examples of the present disclosure, other and further examples of the disclosure may be devised without departing from the basic scope thereof, and the scope thereof is determined by the claims that follow.

What is claimed is:

1. A device, comprising:
a plurality of optical device structures disposed on a surface of a substrate, the plurality of optical device structures including a nanoparticle imprint material; and
an encapsulation layer disposed over at least a top surface and one sidewall of each optical device structure of the plurality of optical device structures, the encapsulation layer amorphous or substantially amorphous, the encapsulation layer including a niobium oxide, the niobium oxide selected from the group consisting of niobium monoxide (NbO), niobium dioxide (NbO₂), niobium pentoxide (Nb₂O₅), Nb₁₂O₂₉, Nb₄₇O₁₁₆, or Nb3n₊₁O₈ₙ₋₂, where n is 5 to 8.

2. The device of claim 1, wherein the nanoparticle imprint material includes one or more of a spin on glass (SOG), flowable SOG, organic, inorganic, hybrid organic, and inorganic nanoimprintable materials.

3. The device of claim 2, wherein the nanoparticle imprint material further includes silicon oxycarbide (SiOC), titanium dioxide (TiO₂), silicon dioxide (SiO₂), vanadium (IV) oxide (VO₂), aluminum oxide (Al₂O₃), indium tin oxide (ITO), zinc oxide (ZnO), tantalum pentoxide (Ta₂O₅), silicon nitride (Si₃N₄), titanium nitride (TiN), and zirconium dioxide (ZrO₂) containing materials.

4. The device of claim 1, wherein the nanoparticle imprint material includes a plurality of nanoparticles and adjacent nanoparticles of the plurality of nanoparticles define a grain boundary.

5. The device of claim 1, wherein the plurality of optical device structures have a refractive index of greater than about 1.5.

6. The device of claim 1, wherein the encapsulation layer has a refractive index between about 2.1 to about 2.5.

7. The device of claim 1, wherein the encapsulation layer is disposed using a liquid material pour casting process, a spin-on coating process, a liquid spray coating process, a dry powder coating process, a screen printing process, a doctor blading process, a PVD process, a CVD process, a FCVD process, a PECVD process, or an ALD process.

8. A device, comprising:
a plurality of optical device structures disposed on a substrate, the plurality of optical device structures including a nanoparticle imprint material;
a buffer layer disposed over a top surface and at least one sidewall of each optical device structure of the plurality of optical device structures; and
an encapsulation layer disposed over the buffer layer, the encapsulation layer including materials having a refractive index greater than or equal to 2.0.

9. The device of claim 8, wherein the nanoparticle imprint material includes one or more of a spin on glass (SOG), flowable SOG, organic, inorganic, hybrid organic, and inorganic nanoimprintable materials.

10. The device of claim 9, wherein the nanoparticle imprint material further includes silicon oxycarbide (SiOC), titanium dioxide (TiO₂), silicon dioxide (SiO₂), vanadium (IV) oxide (VO₂), aluminum oxide (Al₂O₃), indium tin oxide (ITO), zinc oxide (ZnO), tantalum pentoxide (Ta₂O₅), silicon nitride (Si₃N₄), titanium nitride (TiN), and zirconium dioxide (ZrO₂) containing materials.

11. The device of claim 8, wherein the nanoparticle imprint material includes a plurality of nanoparticles and adjacent nanoparticles of the plurality of nanoparticles define a grain boundary.

12. The device of claim 8, wherein the plurality of optical device structures have a refractive index of greater than about 1.5.

13. The device of claim 8, wherein the materials of the encapsulation layer include one or more of silicon oxycarbide, titanium oxide, silicon oxide, vanadium oxide, aluminum oxide, aluminum-doped zinc oxide, indium tin oxide, tin dioxide, zinc oxide, tantalum pentoxide, silicon nitride, silicon oxynitride, zirconium oxide, niobium oxide, cadmium stannate, or silicon carbon-nitride.

14. The device of claim 8, wherein the encapsulation layer is disposed using a liquid material pour casting process, a spin-on coating process, a liquid spray coating process, a dry powder coating process, a screen printing process, a doctor blading process, a PVD process, a CVD process, a FCVD process, a PECVD process, or an ALD process.

15. The device of claim 8, wherein the buffer layer has a refractive index of greater than or equal to about 1.8.

16. A method, comprising:
imprinting a stamp into a nanoparticle imprint material disposed on a surface of a substrate to form a plurality of optical device structures;
subjecting the nanoparticle imprint material to a cure process;
releasing the stamp from the nanoparticle imprint material; and
disposing an encapsulation layer to be conformal over at least a top surface and one sidewall of each optical device structure of the plurality of optical device structures, the encapsulation layer amorphous or substantially amorphous, the encapsulation layer including a niobium oxide, the niobium oxide selected from the group consisting of niobium monoxide (NbO), niobium dioxide (NbO₂), niobium pentoxide (Nb₂O₅), Nb₁₂O₂₉, Nb₄₇O₁₁₆, or Nb3n₊₁O₈ₙ₋₂, where n is 5 to 8.

17. The method of claim 16, wherein subjecting the nanoparticle imprint material to a cure process comprises forming a plurality of nanoparticles in the nanoparticle imprint material and adjacent nanoparticles of the plurality of nanoparticles define grain boundaries.

18. The method of claim 16, further comprising an anneal process after the stamp is released.

19. The method of claim 16, wherein the niobium oxide further includes Nb₈O₁₉ and Nb₁₆O₃₈.

20. The method of claim 16, wherein disposing the encapsulation layer comprises using a liquid material pour casting process, a spin-on coating process, a liquid spray coating process, a dry powder coating process, a screen printing process, a doctor blading process, a PVD process, a CVD process, a FCVD process, a PECVD process, or an ALD process.
